(19) United States
(12) Patent Application Publication
(10) Pub. No.: US 2008/0130023 A1
(43) Pub. Date: Jun. 5, 2008

(54) Color Reproduction on Translucent or Transparent Media

(75) Inventors: Maria Jesus Perez, Rubi Barcelona (ES); Johan Lammens, Sant Cugat Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/666,029

(22) PCT Filed: Oct. 28, 2004
(86) PCT No.: PCT/EP04/52686

§ 371 Date: Oct. 1, 2007

(51) Int. Cl. G06F 15/00

(52) U.S. Cl. 358/1.9

(57) ABSTRACT

A method of generating a device color profile for printing, with a printing device, on a translucent or transparent media. It includes: printing a profiling target on the media; measuring color values produced by the profiling target, when illuminated in transmission and when illuminated in reflection, in a device-independent color space; combining the transmission and reflection color values into combined transmission-reflection color values and creating a combined transmission-reflection profile mapping color values from a device-dependent color space to the device-independent color space; reversing the combined transmission-reflection profile, thereby obtaining the device color profile. The device color profile maps color values from a device-independent color space to a device-dependent color space in a manner which represents a color-reproduction compromise between transmission and reflection.

### FIELD OF THE INVENTION

The present invention relates generally to color reproduction on translucent or transparent media and, for example, to a method of generating a device color profile, a computer, a printing device, a machine-readable medium and a propagated signal with a device color profile.

### BACKGROUND OF THE INVENTION

Color management addresses the aim of printing or displaying images that look like realistic depictions of the things they portray. Typically, a color-output device uses a device-dependent color model (or “color space”), such as RGB (Red Green Blue) in computer displays and CMYK (Cyan Magenta Yellow Black) in printers. Red, green and blue, or cyan, magenta and yellow, are the primary colors of these color models. A particular output color is produced by the output device by combining red, green and blue light (by output devices using additive color mixing, such as displays) or by printing dots with cyan, magenta yellow colorants (by output devices using subtractive color mixing, such as printers). Since mixing all three primary colors to obtain black would consume lot of colorant, printers usually use black (“Key”) as a color in addition to the primary colors CMY.

Strictly speaking, the CMYK values used in a printing device do not refer to colors, but they specify the amounts of the different colorants (inks, toners, etc.) which are to be used to print in a pixel or dot. Generally, the same set of CMYK numbers will produce different colors on different devices or, on the same device, on different print media (e.g. different types of paper).

Device-independent color models have been defined to enable colors to be characterized in a device-independent way. Some of these color models are based on the fact that the human eye has three different receptors for color, called long-, medium-, and short-wave length (or L, M, and S) receptors. Light with a certain wave length spectrum stimulates the LMS receptors with different strengths; the term “tristimulus” refers to the response-value triple of the LMS receptors to a certain wave length distribution (strictly speaking, the term “tristimulus” refers to experiments and measurements of human color vision involving three color stimuli, which the test subject uses to match a target stimulus; see B. Fraser et al., Real Word Color Management, Peachpit Press, 2003, p. 18 and 19). The CIE (Commission Internationale de L'Eclairage, or the International Commission on Illumination) has defined spectral response curves (“CIE color matching functions”) which correspond to the LMS photoreceptor sensitivities of a standard observer (see, for example, C. Poynton, A Technical Introduction to Digital Video, John Wiley & Sons, Inc., 1996, p. 123, FIG. 7.4). The tristimulus values of the standard observer's color matching functions are also called CIE XYZ values; the corresponding color space is also called CIE XYZ color space. As the CIE XYZ representation refers to colors perceived by the standard observer, it is device-independent, in contrast to a CMYK representation which specifies amounts of different colorants in a particular printing device, which is therefore device-dependent.

Other device-independent color models have been defined which are not standard-observer based, but are related to video-display color representations (i.e. RGB representations), for example Adobe® RGB (see Fraser, pp. 266-267) and sRGB (see, for example, M. Stokes et al.: What is sRGB, undated, http://www.srgb.com/srgboverview/sld001.htm). However, since such RGB color representations do not model the human visual system (but rather typical “phosphors” used in display screens), a pair of colors which produce the same color sensation to the standard observer may produce different RGB measurements (a similar effect, called “scanner metamerism” is produced by scanners, since many scanners are equipped with RGB detectors, see Fraser, pp. 29 to 30). Nevertheless, since colors on the Internet are usually represented in device-independent sRGB, source data are now often sRGB data;

furthermore, many color management applications, such as Adobe® Photoshop®, use device-independent RGB as an “intermediate color space” in which colors and color mappings can be edited and modified.

Since the light from a non-luminescent object is reflected light, its spectral distribution and, therefore, the object's color seen by an observer, depends on the spectral distribution of the light source illuminating the object, called the “illuminant”. The CIE has therefore also specified a number of CIE Standard Illuminants. Due to this dependency, the illuminant used has also to be specified when a printing device is supposed to produce a certain color. The most commonly used CIE Standard Illuminants are D50and D65, which simulate daylight and correspond to color temperatures of 5000 K and 6504 K (see Fraser, pp. 11 and 12).

The CIE XYZ color space is a linear system since, for example, doubling the short-wavelength density of a spectrum will double the response of the corresponding receptor; i.e. the S value will be doubled. However, the human reception is not linear; it rather shows a roughly logarithmic response to luminance. Therefore, equal distances in the CIE XYZ color space will be perceived differently at different absolute-saturation levels—the distances are also said to be “distorted”. As an attempt to reduce this distortion, perceptually uniform color spaces have been defined, for example CIE LAB. In the CIE LAB color space, distances between two points predict how different the two colors represented by the points will appear to the human observer (see Fraser, pp. 40-42). CIE LAB is a device-independent color space, such as CIE XYZ; CIE LAB values can be calculated from CIE XYZ values by a non-linear transformation (which is, for example, described in Poynton, pp. 130-132).

As already mentioned at the outset, the numbers in a device-dependent representation (e.g. a CMYK representation) do not really represent color. Instead, they represent the amounts of colorants (e.g. the amounts of the different inks used in a printing device) to make a color. The same set of CMYK numbers will produce different colors on different devices (and media). In order to produce the same color on different devices (or different media), the color may be expressed in a device-independent color space (such as CIE XYZ or CIE LAB), and then converted into the device-dependent (and media-dependent) color representation that specifies what amounts of colorants are to be applied in order to reproduce the desired color on the particular reproduction device and media. The mappings which correlate device-independent color values with device-dependent color values are called transforms, and their data representations are called profiles. A transform that converts color values in a device-independent representation into a device-dependent representation is known as the “forward transform”, and a transform that converts color values from the device-dependent representation into a device-independent representation is known as the “backwards transform”. As a device-independent representation is also used as a “profile connection space”, or PCS, the forward and backwards transforms are also called the PCS-to-device transform and the device-to-PCS transform (see Fraser, pp. 99-110). In principle, a profile may be in the form of a matrix, and a transform may be performed by a matrix multiplication (e.g. by multiplying the PCS components of a color to be reproduced (e.g. its CIE XYZ components) with the forward-transform matrix). However, for more complex devices, such as printers, the profiles are typically in the form of lookup tables (LUTs). An LUT is a table of numbers that provides, for certain input values (colors represented in an input color space), the corresponding output values (the corresponding colors represented in an output color space). The tables that specify the backwards transform are known as the AtoB tables, while the tables that specify the forward transform are known as BtoA tables (see Fraser, p. 102).

If an input value is between the discrete input data points of an LUT, the corresponding output value is usually approximated by an interpolation procedure. For example, the input data points closest to the input value as well as their distances to the input value are first determined, then the corresponding output values are looked up in the LUT, and an interpolation is made between them, taking the inverse distances of the input value to the corresponding input data points as the weights of the output data points in the interpolation procedure.

Once a transform is known in one direction, e.g. the backwards transform, represented by a BtoA table, the inverse transform (e.g. the forward transform) may be determined by reversing the known profile (e.g. by reversing the BtoA table to obtain the AtoB table). A matrix-based profile may be inverted by determining the inverse of the matrix representing the transform. An LUT-based profile may be reversed by transforming it into a representation in which, in principle, the output values of the original LUT take the role of the input values of the new LUT, and the corresponding original input values take the role of the new LUT's output values. To construct the reversed LUT, an original output value required for the reversal can be found by a search procedure, and by interpolating the discrete original output values closest to the required output (this will give the new input value) and by interpolating the corresponding original input values (this will give the new output value). A difficulty may arise from the fact that the transforms are not always one-to-one, since the device-independent color space has typically three components (e.g. XYZ or LAB), whereas the device-dependent color space often has four components (e.g. CMYK). Ambiguities may be due to the fact that gray and black tones may either be reproduced by CMY combinations, or by K. By using parameters like “black start” (the point where black ink is first introduced), “black shape” (the rate at which black ink is introduced as the color gets darker), “black width” (the strength of GCR (Gray Component Replacement) which dictates how far from the neutral axis black is introduced into color combinations), such ambiguities can be removed (see, for example, Fraser, pp. 177-180).

Another issue is related to the range of colors which can be represented in a certain color representation and reproduced by a certain reproduction device. This is called the color gamut of the color space or the device. Generally, the device-independent and the device-dependent color spaces may have different color gamuts (see Fraser, page 64 and pp. 72-78). If, for example, the device-independent representation has a wider color gamut than the device-dependent representation (i.e. than the reproduction device) certain colors, called “out-of-gamut colors”, are not reproducible in the device-dependent color space. Since those colors are not reproducible, they are replaced by other colors. Four different methods for handling out-of-gamut colors are well known and standardized by the CIE, called rendering intents: perceptual and saturation renderings use gamut compression, desaturating all the colors in the source space so that they fit into the destination gamut; relative and absolute colorimetric renderings use gamut clipping, where all out-of-gamut colors simply get clipped to the closest reproducible hue (see Fraser, pp. 88-92). The differing rendering intents are included in the backwards and forward transforms; therefore, a complete device profile typically includes four LUTs, one for each rendering intent, to enable a desired rendering intent to be chosen by the user.

Technically, device color profiles are usually in the form of data stored in files. An attempt has been made by a consortium called “International Color Consortium” (ICC) to define a standard file format for device color profiles (see Specification ICC.1: 2001-12, 2002, File Format for Color Profiles (Version 4.0.0), pages i to x and 1 to 28). In the PC world, such device color profiles are called ICM profiles; however, since they both relate to a device's specific color space values to a known reference space, the term “ICC profile” is used herein so as to cover “ICM profiles” also, if “ICM” is not expressly mentioned (see H. Johnson, Mastering Digital Printing, Muska & Lipman Publishing, 2003, p. 132).

In many applications, the source data which represent the images to be printed are not represented in a standard-observer-based color space, such as CIE XYZ or CIE LAB. Rather, they are often expressed in a device-dependent color model (for example, an RGB color space of a particular scanning device) or a device-independent RGB color model, such as sRGB. The transform from this (device-dependent or device-independent) input color space to an intermediate color space is represented by “source profiles” which correlate input color values (e.g. expressed in device-dependent RGB or sRGB) with the intermediate-color-space values. The intermediate color space is typically a standard-observer-based color space, such as CIE XYZ or CIE LAB. The mapping from the intermediate color space to the output device's color space is then defined by the above-mentioned device color profiles, which are therefore also called destination profiles. Since the intermediate color space connects the source and destination profiles, it is also called profile connection space, or PCS (PCS has already been mentioned above). The source profile and the destination profile may be combined to form tables which directly map the source image (e.g. expressed in device-dependent RGB or sRGB) to an output-device representation (e.g. expressed in CMYK) of a particular printing device (see, for example, Fraser, pp. 96-97). Such profiles or tables which directly map source images to output images are also called “device color profiles” hereinafter; i.e. this term includes the transforms “PCS-to-device” and “source-to-device”.

Since a device color profile is, in a sense, the device's finger print, it is natural to assign the device color profile (or profiles, for different media) to the output device. For example, the printer drivers provided by operating-system or printer manufacturers will typically include predefined device color profiles for the particular printer considered and for different media to enable the computer to which the printer is connected to receive or generate source image data with colors represented in an input color space or the PCS and to transform the input image data to device-dependent output data which the printer uses to reproduce the images in true colors. However, a device color profile may also be assigned to an image. For example, profiles may be embedded in a document and assigned to images within the document (see, for example, Fraser, pp. 93-94). This enables users to transparently move color data between different computers, networks and operating systems without having to worry if the required profiles are present on the destination system.

Since the pre-defined profiles may not be sufficient for certain purposes (e.g. for media not covered by the predefined profiles), and output devices do not always remain stable over time, users of output devices may have a need to create new device color profiles, or update existing ones. The process of creating and updating device color profiles a part of what is called “color management”.

There are commercially available color-management software packages which enable device color profiles to be created, for example Heidelberg/PrintOpen®; Agfa/ColorTune Pro®; ColorSavvy/ProfileSavvy Suite®; Delta-E/Profiler®; GretagMacbeth/ProfileMaker®; Imation/Spectral Profiler®; ITEC Color Solutions/ColorBlind®; Kodak/ColorFlow®; Monaco Systems/MonacoProfiler®; Praxisoft/Compass Profiler®; Scitex/Profile Wizard®, etc. The process of creating a device color profile performed by such software packages typically includes three main activities, as follows:

(i) first, a profiling target is printed on the reproduction device (output device) and the media to which the profile refers; a profiling target is a set of different color patches, for example patches will contain 0%, 10%, 20%, 40%, 70% and 100% of each colorant in all possible combinations. For example, a standard target for profiling CMYK output devices is the IT8.7/3 target (see Fraser, pp. 104-106). Furthermore, there are many other vendor-specific profiling targets which are, for example, described in Fraser, pp. 173-175. In principle, a user may also use his/her own custom targets, based on his/her own definition of a suitable color-patch arrangement;

(ii) then, the color values produced by the different color patches of the profiling target are measured with a color measurement device, such as a spectrophotometer (see, for example, Fraser, pp. 163-169). The color values measured represent the colors perceived by a standard observer; typically the colors are represented as components of the CIE XYZ or CIE LAB color space. Optionally, multiple targets are printed and measured, and the results obtained are averaged (see Fraser, p. 176). The software's color management module (CMM)—also called color management engine—produces the device-to-PCS transform based on the colors measured for the different amounts of colorants applied to the target's color patches. As a result, color profiles are obtained which map color values from the device-dependent color space (CMYK) to a device-independent color space (e.g. CIE LAB or CIE XYZ). The obtained profile includes the AtoB tables that describe which amounts of CMYK colorants result in which colors, expressed in CIE LAB or CIE XYZ;

(iii) finally, the CMM reverses the device-to-PCS profile (with the AtoB tables) into a PCS-to-device profile, e.g. a profile which maps color values from the device-independent color space (e.g. CIE LAB or CIE XYZ) to the device-dependent color space (e.g. the printer's CYMK color space the components of which represent the amounts of colorants to be used to produce the desired input color).

This process, which forms part of the “color management workflow”, is, for example, described in Fraser, pp. 99-110 and 161-206.

Color management services not only include the creation of device color profiles, but also the editing and modifying of color profiles and tables, and converting color data from an input or intermediate color space to the device color space. Some of these color-management services are usually provided as part of the computer's operating system (OS). For example, Apple's ColorSync® and Microsoft's ICM® (Image Color Management) are the technologies that provide color management services as part of the Macintosh® and Windows® operating systems (see Fraser, pp. 293-304). Application and device drivers, such as scanner and printer drivers, often use OS-level color management services.

If no applications are used to perform explicit color-management tasks, the device drivers are usually responsible for the conversion of color data from the input color space to the device color space, using OS-level services, as mentioned above.

Applications to perform explicit color-management tasks are for example, Adobe® Photoshop®, Adobe Illustrator®, Adobe InDesign®, Marcomedia®, FreeHand®, CorelDRAW®, QuarkXPress®, etc. Such color management systems typically provide the above-mentioned color management services, using OS-level services. Many color-management applications, such as the Adobe applications, use device-independent RGB as an intermediate color space, rather than CIE LAB (see Fraser, pp. 266-267). Usually, such applications therefore rely on four profiles to transform color values from the input to the output color space: the first profile represents the transform from the input color space (e.g. input-device-dependent RGB) to a standard-observer-based color space (such as CIE LAB); the second profile represents the transform from the standard-observer-based color space to the application's intermediate color space (such as Adobe RGB or sRGB); the third profile represents the transform from the application's intermediate color space to a standard-observer-based color space (such as CIE LAB), and the fourth profile represents the transform from the standard-observer-based color space to the output device's color space (such as CMYK). Consequently, there are two profile connection spaces, between the first and second transforms and the third and fourth transforms. In practice, direct-mapping tables are generated which combine the first and second transforms and the third and fourth transforms, so that actually two conversions are made, from the input color space to the application's intermediate color space, and from application's intermediate color space to the output device's color space (see Fraser, pp. 266-268). If the color-management application is responsible for converting colors from the input-color space or the intermediate color space to the output device's color space, the conversion by the device driver is normally inactivated.

As already mentioned above, generally, device color profiles are not only device-dependent, but also media-dependent. For example, known ink-jet printers may have different media options enabling the user not only to print on paper, but also on transparent or translucent media, such as transparencies or films (an example of prints on translucent films is shown in H. Johnson, pp. 198-199). U.S. Pat. No. 6,079,807 discloses a printer which automatically detects whether the media is paper or a transparency, and automatically chooses a paper print mode or a transparency print mode. In the transparency print mode, more ink is applied than in the paper print mode, in order to achieve bright vibrant colors. According to European Patent EP 0 695 080 B1, which pertains to an electrophotographic image recording apparatus, a quantity of toner used for producing images on transparencies is less than that used for paper, so that fusing of toner grains is facilitated in the transparency-recording mode.

### SUMMARY OF THE INVENTION

A first aspect of the invention is directed to a method of generating a device color profile for printing, with a printing device, on a translucent or transparent media. The method comprises: printing a profiling target on the media; measuring color values produced by the profiling target, when illuminated in transmission and when illuminated in reflection, in a device-independent color space; combining the transmission and reflection color values into combined transmission-reflection color values and creating a combined transmission-reflection profile mapping color values from a device-dependent color space to the device-independent color space; reversing the combined transmission-reflection profile, thereby obtaining a device color profile. The color device profile maps color values from a device-independent color space to the device-dependent color space in a manner which represents a color-reproduction compromise between transmission and reflection.

According to another aspect, a computer is provided arranged to produce print data enabling a printing device to print a color image on a translucent or transparent media. The computer is equipped with a device color profile, or a table, which comprises a mapping of color values from a device-independent color space, or an input-color space, to a printing-device-dependent color space in a manner which represents a color-reproduction compromise for the media when observed in transmission and in reflection. The device color profile incorporates a combination of transmission and reflection color values.

According to another aspect, a printing device is provided arranged to print on a translucent or transparent media. The printing device is equipped with a device color profile, or a table, which comprises a mapping of color values from a device-independent color space, or an input-color space, to a printing-device-dependent color space in a manner which represents a color-reproduction compromise for the media when observed in transmission and in reflection. The device color profile incorporates a combination of transmission and reflection color values.

According to another aspect, a machine-readable medium with data stored on it is provided. The data comprise a device color profile which represents a mapping of color values from a device-independent color space to a device-dependent color space, for providing a printing device with information enabling it to translate input-color values expressed in the device-independent color space. The device color profile, when stored in or accessed by the printing device or a computer arranged to control the printing device, enables the printing device to reproduce colors on a translucent or transparent media in a manner which represents a color-reproduction compromise for the media when observed in transmission and in reflection. The device color profile incorporates a combination of transmission and reflection color values.

According to another aspect, a propagated signal is provided carried on an electromagnetic waveform comprising a representation of a device color profile. The device color profile represents a mapping of color values from a device-independent color space to a device-dependent color space, for providing a printing device with information enabling it to translate input-color values expressed in the device-independent color space. The device color profile, when stored in or accessed by the printing device or a computer arranged to control the printing device, enables the printing device to reproduce colors on a translucent or transparent media in a manner which represents a color-reproduction compromise for the media when observed in transmission and in reflection. The device color profile incorporates a combination of transmission and reflection color values.

Other features are inherent in the methods and products disclosed or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 illustrates the viewing conditions of a printed transparency for an inside observer;

FIG. 2 illustrates the viewing conditions of a printed transparency similar to FIG. 1, but for an outside observer;

FIG. 3 illustrates how colors on a transparency are perceived for the different viewing conditions and different orientations of the transparency's print side;

FIGS. 4a-b show an orientation of a printed transparency according to an embodiment of the invention in which the differences between the colors perceived in transmission and reflection perception are relatively small;

FIGS. 5a-c illustrate how colors are perceived in transmission and reflection when printed with a transmission color profile, a reflection color profile, and a combined transmission-reflection color profile according to an embodiment of the invention;

FIG. 6 illustrates a part of an exemplary profiling target;

FIG. 7 illustrates a measurement of the colors produced by the profiling target in transmission and reflection, according to an embodiment of the invention;

FIG. 8 is an exemplary workflow diagram illustrating the generation of combined transmission-reflection device color profiles, according to an embodiment of the invention;

FIG. 9 is a graph illustrating a limitation of the amount of black colorant used, according to an embodiment of the invention;

FIG. 10 is an exemplary high-level flow diagram including the workflow of FIG. 8, a transmission of the generated device color profile and a printing operation using the device color profile, according to an embodiment of the invention;

FIG. 11 illustrates a device color profile, according to an embodiment of the invention;

FIG. 12 is a high-level diagram of an exemplary computer's program structure including device color profiles, for example a device color profile according to FIG. 11;

FIG. 13 illustrates a printing device with a device color profile, for example a device color profile according to FIG. 11;

FIG. 14 is a high-level architecture diagram of a computer system with device color profiles stored, for example device color profiles according to FIG. 11.

The drawings and the description of the drawings are of embodiments of the invention and not of the invention itself.

### DESCRIPTION OF THE PREFERRED EMBODIMENTS

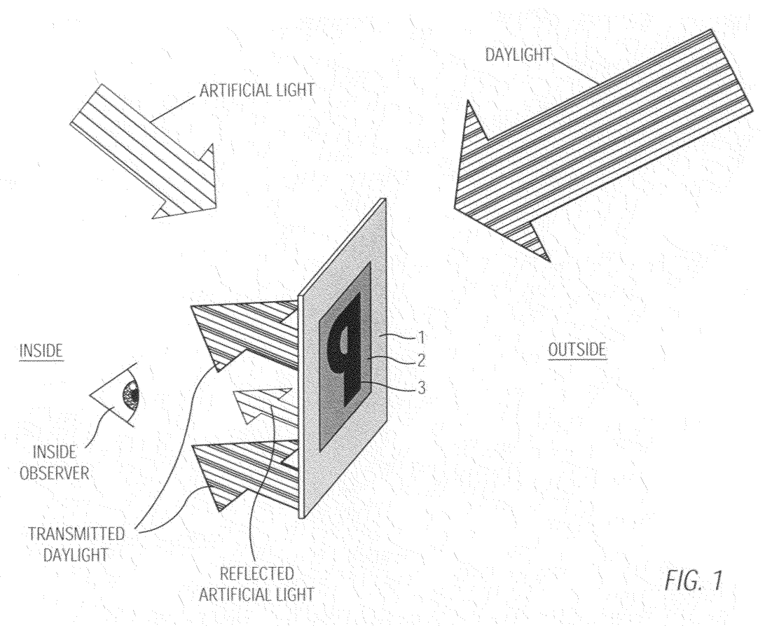

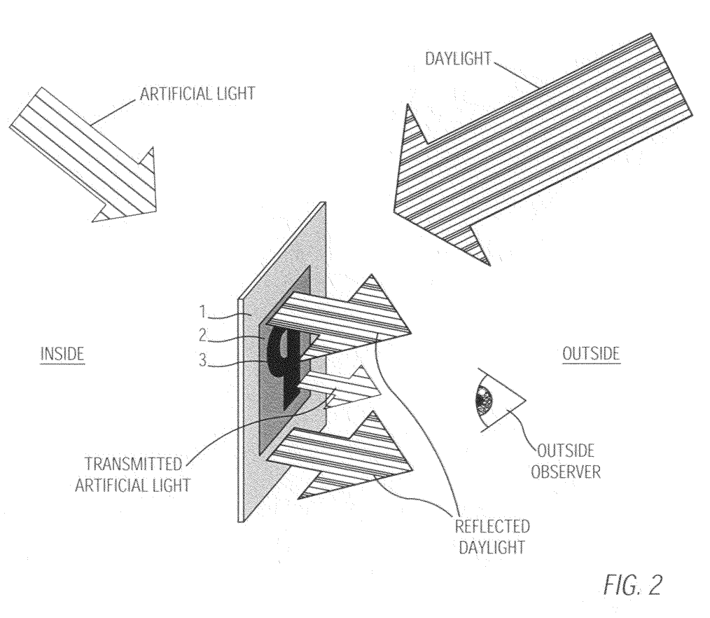

FIGS. 1 and 2 illustrate the viewing conditions of a printed transparency for an inside and an outside observer. Before proceeding further with the detailed description of FIGS. 1 and 2, however, a few items of the embodiments will be discussed.

Typically, images printed on translucent or transparent media are destined to be viewed in transmission. The typical case is, for example, shown in Johnson, page 198, in which images printed on translucent films are adhered to a window illuminated from outside by daylight; the images are viewed from inside, i.e. in transmission. However, sometimes such images may also be viewed from outside, for example images on translucent or transparent media adhered to display windows of shops.

It has been recognized that, in such cases, the colors perceived of such an image are generally not the same when it is viewed from the outside as it is when viewed from the inside. One of the reasons for this is that, typically, the inside illumination (usually artificial light) has a much lower intensity than the external light (daylight). Due to this difference in intensity, the outside observer mainly sees daylight reflected by the image, whereas the inside observer mainly sees daylight transmitted through the image. By contrast, normally the intensities of artificial light seen by the external observer in transmission, and by the internal observer in reflection, are relatively low, and therefore negligible.

When an image is printed using a transmission-color profile, an inside observer viewing the image in transmission will see a correct color saturation, but an outside observer viewing the image in reflection will often see an unsatisfactory color saturation. Vice versa, when the image is printed using a reflection-color profile, the outside observer will see a correct color saturation, but the inside observer will see an unsatisfactory color saturation.

According to the embodiments, a generally satisfactory color saturation for both the inside and the outside observer is achieved by a color-reproduction compromise between transmission and reflection. This compromise is achieved by a special device color profile which is neither a pure transmission nor a pure reflection profile, but rather a combined transmission-reflection profile. The compromise device color profile is a data representation of a transform which specifies, for a color expressed in a device-independent color space, what amounts of colorants are to be applied to the transparent or translucent media in order to reproduce the desired color in a manner which is a compromise between correct color saturation when viewed in transmission and in reflection.

As mentioned in the background section, a forward transform can be found once the corresponding backward transform is known. In some embodiments, the profile is in the form of a matrix, and the transform may be performed by a matrix multiplication (e.g. by multiplying device-independent components of a color to be reproduced with the forward-transform matrix). In other embodiments, for more complex devices, such as printers, the profiles are in the form of lookup tables (LUTs) which represent the mapping by discrete input values to which output values are assigned; for other input values but the discrete ones, an interpolation may be made. For example, the input data points closest to the input value as well as their distances to the input value are first determined, then the corresponding output values are looked up in the LUT, and an interpolation is made between them, taking the inverse distances of the input value to the corresponding input data points as the weights of the output data points in the interpolation procedure. Thus, once the backwards transform is known, the inverse transform (i.e. the forward transform) can be determined.

In some of the embodiments, the generation of the compromise device color profile starts by printing, with the printing device, a profiling target on the transparent or translucent media. A profiling target is a set of different color patches, for example, 0%, 10%, 20%, 40%, 70% and 100% of each of the printing devices' colorants in all possible combinations. In the embodiments, a standard target, such as the IT8.7/3 target, a vendor-specific target or a custom target may be used. For each color patch of the target, the amount of colorant which has been used to print it (e.g. in a CMYK representation, if the printer has CMYK inks) is known by definition. In other embodiments, rather than printing a profiling target, an already existing profiling is used for the subsequent color measuring process, which will be described below.

In some of the embodiments, the device-dependent color space is a CMY or CMYK color space. Since three-color and four-color printers with lower resolutions tend to show grain in highlight areas, some embodiments use six, seven or even higher-color printers and corresponding color spaces with six, seven or more dimensions. For example, six-color printers have two extra colors, usually a light cyan (called “c”) and a light magenta (called “m”), the complete color space is then CMYKcm. Seven-color printers have an extra low-density black (called “k”) to improve the neutrality of grays (the color space is then XMYKcmk).

Then, the color values produced by the profiling target's different color patches are measured in a device-independent color space. A daylight CIE Standard Illuminant, such as D50 and D65, is used to illuminate the transparent or translucent media for these measurements. The measurements may, for example, be performed by means of a commercially available spectrophotometer detector (see e.g. Fraser, pp. 163-169). In some of the embodiments, the color values measured represent the colors perceived by a standard observer; typically the colors are represented as components of the CIE XYZ (the color values measured then represent the standard observer's tristimulus response to the profiling target) or the CIE LAB color space. In other embodiments, however, the device-independent color space is not standard-observer based but, for example, display-related, such as the sRGB or the RGB Adobe® color spaces.

Measuring color values produced by profiling targets is, in principle, known in the prior art, as described in the background section. However, in contrast to known color-management workflows, in the embodiments two different sets of measurements are made: one set of measurements is made in transmission, another set in reflection. In the transmission measurements, the illuminant and the detector are placed on different sides of the translucent or transparent media with the target printed on it; in the reflection measurements the illuminant and the detector are placed on the same side, for example in a 0°/45° geometry in which the target is illuminated by a light beam perpendicular to its surface and the detector reads the light that is reflected at a 45° angle.

The measured transmission color values are then combined with the measured reflection color values, thereby forming combined transmission-reflection color values. In some of the embodiments in which the color values are measured in a linear, but perceptually non-uniform color space, such as the CIE XYZ color space, the combination of the measured transmission and reflection color values is also performed in this linear, perceptually non-uniform color-space representation. In other embodiments, the target colors may directly be measured in a non-linear, but perceptually uniform color space (e.g. CIE LAB), or may be transformed into such a color space before the combination of transmission and reflection values is made. However, due to the non-linear characteristics of perceptually uniform color spaces, the first mentioned alternative in which the measured transmission and reflection color values are combined in the linear, perceptually non-uniform color space will generally give better results.

In some of the embodiments, the combined transmission-reflection color values are linear combinations of the individual transmission and reflection color values. For example, the transmission and reflection color values are combined with proportions X % transmission and 100%−X % reflection, wherein X lies in a range from 30 to 70, i.e. in a range from 30% transmission/70% reflection to 70% transmission/30% reflection. In some of the embodiments, in the combined transmission-reflection color values, the proportion of the transmission color values is larger than the proportion of the reflection color values. Factors that may cause the required weighting to vary are the type of the transparency used, the color temperatures and average relative intensities of the lighting from the inside and outside, etc. The correct weighting of the transmission and reflection color values can, for example, be determined by a trial and error procedure.

In order to reduce errors in the profile generation, in some embodiments not only one profiling target is printed and measured, but several different profiling targets. The transmission and reflection color values produced by these different profiling targets are then measured, and results of the different sets of measurements are averaged. In some embodiments the averaging of transmission and reflection data is first done separately, and the averaged transmission and reflection values are then combined, whereas in other embodiments, first the transmission and reflection data from each target are combined, and then the individual combined transmission-reflection values are averaged. In still other embodiments several color measurements are performed and averaged using the same profiling target but, for example, different illuminants and/or measurement angles.

Since equal distances in a linear color space, such as CIE XYZ, will be perceived differently at different absolute-saturation levels, the distances are distorted. Perceptually uniform color spaces, for example CIE LAB, reduce this distortion. In the CIE LAB color space, distances between two points predict how different the two colors represented by the points will appear to the human observer. CIE LAB is a device-independent color space, such as CIE XYZ; CIE LAB values are calculated from CIE XYZ values by a known non-linear transformation (see e.g. Fraser, pp. 40-42). In order to avoid distortions in the interpolation procedures which will later be used to reverse the backwards transform into the forward transform and to map input color values to output color values, in some of the embodiments the combined transmission-reflection values (or an already generated combined transmission-reflection profile) are first transformed into a perceptually uniform color-space representation (for example, CIE LAB), before the reversal to obtain the forward transform is made.

The combined transmission-reflection color values are then, after having transformed them to CIE LAB, used as an input for a color-management workflow for producing device color profiles from input values. A commercially available color-management software package may be used to create the device color profiles from the combined transmission-reflection color values, for example Heidelberg/PrintOpen®; Agfa/ColorTune Pro®; ColorSavvy/ProfileSavvy Suite®; Delta-E/Profiler®; GretagMacbeth/ProfileMaker®; Imation/Spectral Profiler®; ITEC Color Solutions/ColorBlind®; Kodak/ColorFlow®; Monaco Systems/MonacoProfiler®; Praxisoft/Compass Profiler®; Scitex/Profile Wizard®, etc. First, a profile is produced by the software's color management machine (CMM) which represents a transform from the device-dependent color space (e.g. CMYK) to the device-independent color space (e.g. CIE LAB). The profile includes the AtoB tables that describe which amounts of colorants (e.g. CMYK colorants) used to print the target's color patches result in which “combined transmission-reflection colors” (e.g. expressed in CIE LAB). Since this backwards profile incorporates the combined transmission-reflection color values, it is also called combined backwards transmission-reflection profile.

The combined backwards transmission-reflection profile is then reversed by the software's color management machine (CMM) so that a combined forward transmission-reflection profile is obtained which includes BtoA tables mapping color values from the device-independent color space (e.g. CIE LAB) to the device-dependent color space (e.g. CMYK)—this profile is also simply called “device color profile”.

In embodiments with LUT-based backwards and forward profiles, the CMM reverses the backwards profile by transforming it into a representation in which, in principle, the output values of the original LUT take the role of the input values of the new LUT, and the corresponding original input values take the role of the new LUT's output values. To construct the reversed LUT, for example, some of the software packages find an original output value required for the reversal by a search procedure, and by interpolating the discrete original output values closest to the required output (this will give the new input value) and by interpolating the corresponding original input values (this will give the new output value). To avoid ambiguities due to the fact that that gray and black tones may either be reproduced by CMY combinations, or by K, threshold parameters are applied which control the black reproduction; such parameters are, for example, black start, black shape and black width. The CMM may generate four different BtoA tables which represent different handling of out-of-gamut colors, according to the four different standardized rendering intents, to enable a desired rendering intent to be chosen by the user (perceptual and saturation renderings use gamut compression, desaturating all the colors in the source space so that they fit into the destination gamut; relative and absolute calorimetric renderings use gamut clipping, where all out-of-gamut colors simply get clipped to the closest reproducible hue).

Since the forward profile generated incorporates the combined transmission-reflection color values, it represents a color-reproduction compromise between transmission and reflection. Due to this compromise, the image printed on the translucent or transparent media will produce a satisfactory color perception for both the internal transmission observer and the external reflection observer.

In some of the embodiments, the CMM then generates direct-mapping tables which directly map color values from a source color space (e.g. device-dependent RGB input colors or device-independent RGB colors of an application's intermediate color space) to the printing device's color space. Such a direct mapping is a combination of a first transform from the source color space to the standard-observer based color space (e.g. CIE LAB), and a second transform from the standard-observer based color space to the printing device's color space (the standard-observer based color space is thus the profile connection space, or PCS). The first transform may be represented by a “source profile” which correlates source color values (e.g. in device-dependent RGB or sRGB) with the PCS values. The source profile and the combined transmission-reflection forward profile are combined by the CMM to form a new profile including the direct-mapping tables which directly map the source image to the printing device's representation.

Another issue is the orientation in which the printed translucent or transparent media is viewed. Generally, an image is only printed on one side of the media; consequently, the media has a printside and a backside.

It has been recognized that the two sides, when viewed in transmission, produce very similar color perceptions, whereas, when viewed in reflection, the colors appear rather different. Furthermore, it has been recognized that the backside-reflection view produces a color view more similar to the transmission views than the printside-reflection view. Therefore, the color-reproduction compromise can be made less serious when the backside of the printed media is turned to the outside, to face the external illuminant, and its printed side is turned to the inside, so that it is turned away from the outside illuminant.

In order to generate the combined transmission-reflection profile in a manner consistent with the way the printed transparencies are to be used later, in some of the embodiments the same orientation of the profiling target's printside and backside relative to the light source is used when the color measurements are made; i.e. the target's backside is turned to the light source, and its printside is turned away from the light source during the transmission and reflection measurements. The transparent or translucent media with an image printed on it is later adhered to a window in a consistent manner, i.e. with its backside oriented to the outside daylight. The compromise which had been made between transmission and reflection color reproduction is less than it would be in the other orientation, and a better color perception for both transmission and reflection is thus achieved.

A further issue pertains to the quantity of black colorant applied to the print dots in embodiments using liquid inks. It has been recognized that, at very high concentrations of liquid black ink, the black pigment may start to crystallize, which has the effect of reducing the optical density. Consequently, the optical density as a function of the amount of black colorant first increases, but starts to decrease at a “critical point” at which the optical density is maximum. Therefore, to avoid such a reduction of optical density of black, in some of the embodiments the maximum amount of black ink applied to the transparent media is limited to a value below the critical value.

Different embodiments use different digital-printing technologies for printing the images on the translucent or transparent media. Some of the embodiments use ink-jet printers, for example thermal or piezo drop-on-demand printers, continuous-flow or solid-ink ink-jet printers. Other embodiments use electrophotographic printers (laser printers) with solid or liquid toner, dye sublimation printers or digital photo printers. Liquid ink-jet printers and laser printers with liquid toner are most suitable for printing images on translucent or transparent media which are to be viewed in transmission, since liquid inks are normally more transparent than solid inks.

Embodiments are described of a computer arranged to produce print data which enable a printing device connected to it to print a color image on a translucent or transparent media. For example, the computer is a commercially available multi-purpose desktop or portable computer using the Macintosh® and Windows® operating systems including the ColorSync® or ICM® technologies. In some of the embodiments, the computer is equipped with a device color profile which maps color values from a device-independent color space (e.g. CIE LAB) to the printing device's color space (e.g. CYMK). The device color profile is a file in the ICC or ICM format stored in the computer's memory (e.g. on its hard disk). In other embodiments, the computer has a device color profile in the form of a direct-mapping table, calculated by the OS or a color-management application, which directly maps color values from a source color space (such as device-dependent RGB or sRGB) to the printing device's color space. In both embodiments, the device color profile or the direct-mapping table incorporates combined transmission-reflection color values as described above; consequently, the computer performs the mapping from the device-independent color space or the source color space to the printing device's color space in a manner which represents a color-reproduction compromise for the media when observed in transmission and in reflection.

In some of the embodiments, the device color profile (PCS-to-device or source-to-device), is assigned to and used by the computer's operating system, for example, when the operating system converts color data from a source color space to the device color space for a device driver or an application. In other embodiments, the device color profile may also be used by an application for explicit color management, such as Adobe® Photoshop®, Adobe Illustrator®, Adobe InDesign®, Marcomedia®, FreeHand®, CorelDRAW®, QuarkXPress®, etc. Such a color management application may not only be responsible for converting colors from a source color space (i.e. its intermediate color space or an input color space) to the printing device's color space, but may also enable the device color profile or table to be edited and modified.

In other embodiments, the printing device itself (which may be an ink-jet printer, e.g. thermal or piezo drop-on-demand, continuous-flow or solid-ink, electrophotographic printer with solid or liquid toner, dye sublimation or digital photo printer) is equipped with a device color profile (PCS-to-device or source-to-device), which maps color values from a device-independent color space, or an input-color space, to the printing-device-dependent color space, as described above in connection with the computer. In such embodiments, the printing device itself has the ability to convert color values specified in a device-independent (e.g. sRGB) or a device-dependent color space (e.g. RGB) to its finally used color space (e.g. CMYK), in a manner which represents a color-reproduction compromise for an image to be printed on a translucent or transparent media when observed in transmission and in reflection.

A device color profile is a data product to control color reproduction by a certain reproduction device on certain reproduction media. It may also be commercialized by software manufacturers or profile providers without hardware, either as a “pure” profile, or together with program code, or embedded in a document. Therefore, some of the embodiments pertain to the color-compromise device color profile in the form of such a data product. For example, a “pure” profile may be a single ICC or ICM file, or a direct-mapping-tables-file, or a collection of such files, optionally packed, compressed, encoded, encrypted, etc. Program code with which the profile can be provided may be an operating system, or a plug-in for an operating system, such as a printer driver. A document in which a profile may be embedded may be a file with data representing content, including an image to be reproduced; the profile is assigned to the image, and either forms part of the file or is in a separate file associated with the document file. Embedding profiles in documents enables users to transparently move color data between different computers, networks and operating systems without having to worry if the required profiles are present on the destination system.

The device color profile, if applicable together with the program code or the document in which it may be embedded, is either stored on a machine-readable medium or is represented by a propagated signal carried on an electromagnetic waveform.

The “machine-readable medium” is any medium that is capable of storing or encoding data representing the device color profile. The term “machine-readable medium” shall accordingly be taken to include, for example, solid state memories and, removable and non-removable, optical and magnetic storage media.

A representation in the form of a propagated signal is the embodiment which enables the profile to be distributed over a network, such as the Internet or a private network. As with software in general, this is likely to become the usual way of transmitting and distributing the device color profiles, the program code with such device color profiles, or documents with such device color profiles embedded. The signal is carried on an electromagnetic wave, e.g. a wire-guided wave transmitted over a copper cable, a radio wave transmitted through the air, or a light wave transmitted through an optical fiber.

As described above in connection with the profile generation method and the computer and printer, the data-product embodiments also represent mappings of color values from a device-independent color space, or an input color space to a device-dependent color space. The device profile, when stored in or accessed by the printing device or a computer to control the printing device, enables the printing device to reproduce color on a translucent or transparent media in a manner which represents a color-reduction compromise for the media when observed in transmission and in reflection. As described above, this is due to the fact that the device color profile incorporates a combination of transmission and reflection color values.

FIGS. 1 and 2: Viewing Conditions for an Inside and an Outside Observer:

Returning now to FIGS. 1 and 2, which illustrate the viewing conditions of a printed transparency for an inside and an outside observer respectively. The term “transparency” is used, in the context of the figures, for both transparent and translucent media.

A window 1 is situated between a closed room (“inside”) and outdoors (called “outside”). A transparency 2 with a colored image 3 printed on it is adhered to the window 1. An observer views the image 3, in FIG. 1 from the inside, and in FIG. 2 from the outside. The transparency 2 with the image 3 is illuminated with daylight from the outside, and with artificial light from the inside, as illustrated in FIGS. 1 and 2 by arrows. The light seen by the inside observer (FIG. 1) is a mixture of transmitted daylight and reflected artificial light. By contrast, the light seen by the outside observer is a mixture of reflected daylight and transmitted artificial light. During the day, the intensity of the light coming from outside (the daylight) is typically much higher than that of the artificial light. Furthermore, for a colored image printed on a transparency, the transmission coefficient is typically greater than the reflection coefficient. Owing to these differences in intensities and transmission/reflection coefficients, the predominant part seen from the inside is transmitted daylight, whereas the predominant part seen from outside is reflected daylight. The contributions of reflected artificial light (for the inside observer) and transmitted artificial light (for the outside observer) can consequently be disregarded. Therefore, it is a reasonable assumption that the inside observer sees the image 3 in transmission, whereas the outside observer sees it in reflection.

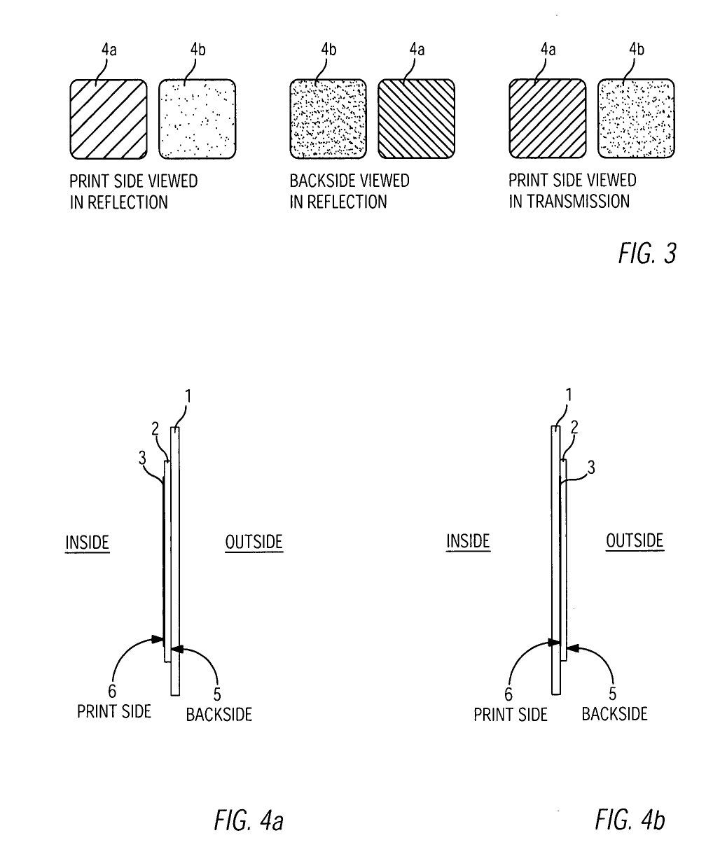

FIG. 3: Color Perception Depends on Transmission/Reflection and Transparency Orientation:

FIG. 3 illustrates the fact that the colors of the image 3 are perceived with different saturations and hues for the transmission and reflection views. Furthermore, the orientation of the transparency also has an influence on the color perceived: generally, when the transparency's print side is viewed in reflection, colors are perceived less saturated than when its backside is viewed in reflection. By contrast, when the transparency is viewed in transmission, the color perceived depends very little on the transparency's orientation; in other words, the colors perceived in transmission are nearly the same, irrespective of whether the print side or the backside is viewed. Furthermore, the difference in perceived color is smaller between the backside-reflection view and the transmission view than that between the print-side-reflection view and the transmission view.

This is illustrated in FIG. 3: two patches of different colors 4a, 4b are shown in three different views/orientations: “Print side viewed in reflection”, “Backside viewed in reflection” and “Print side viewed in transmission” (the backside viewed in transmission is not expressly shown since it is very similar to the “Print side viewed in transmission”). The color of color patch 4a is indicated by hatches, and that of color patch 4b is indicated by dots. The color densities are indicated by the density of hatch lines and dots. The arrangement of the color patches 4a, 4b in the “Backside view in reflection” is mirror-inverted, compared to the other views.

As indicated in the example of FIG. 3, the color saturation of the “Print side viewed in reflection” is significantly lower than that of the “Print side viewed in transmission”, whereas that of the “Backside viewed in reflection” is a little bit higher than, but significantly closer to, that of the “Print side viewed in transmission”.

FIG. 4: Orientation of the Transparency:

FIGS. 4a and b show the orientation of the transparency 2 with the image 3 printed on it in which the differences between the colors perceived in transmission and reflection are relatively small. In a first arrangement shown in FIG. 4a, the transparency 2 is adhered to the inner side of the window 2. The transparency's backside 5 is attached to the window 1, so that its print side 6 faces the inside. Alternatively, if the transparency 2 is adhered to the outside of the window 1, as shown in FIG. 4b, its print side 6 is attached to the window 1, so that its backside 5 faces the outside. In both alternatives, the transparency's backside 5 is oriented to the outside observer, who views the image 3 in reflection. Such an orientation is used both when the measurements for making the device color profile are performed (as will be explained below) and when the printed transparency is finally attached to a window, so as to minimize the differences between the colors perceived in transmission and reflection.

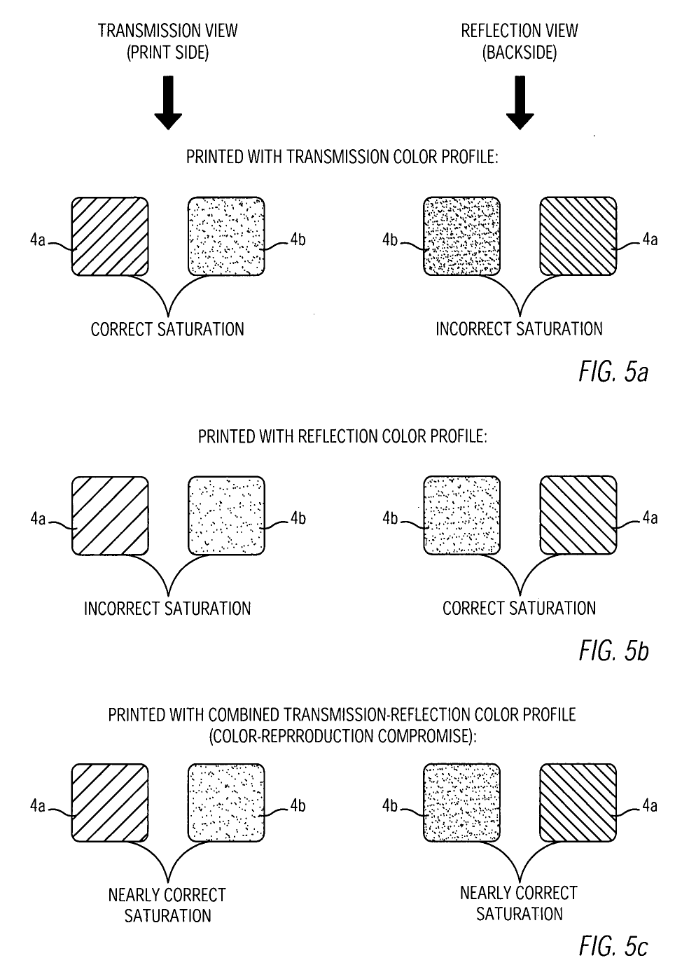

FIG. 5: Transmission, Reflection and Combined Transmission-Reflection Profiles:

FIGS. 5a-c illustrate how colors are perceived in transmission and reflection when printed with a transmission color profile (FIG. 5a), a reflection color profile (FIG. 5b) and a combined transmission-reflection color profile (FIG. 5c). A disturbing effect of the remaining color differences between the transmission and reflecting views (i.e. between the colors shown on the right-hand side and in the middle of FIG. 3) is alleviated, or the color differences are even made unnoticeable, by a color-reproduction compromise between transmission and reflection.

First, FIGS. 5a and 5b illustrate how colors are perceived without such a compromise. FIG. 5a pertains to the case in which an image is printed on a transparency with a color profile produced in the usual way for a transmission view, called “transmission color profile”; FIG. 5b pertains to the complementary case in which the same image is printed on the same type of transparency with a profile produced in a reflection view, called “reflection color profile”. Naturally, if the image printed with the transmission color profile is viewed in transmission, the colors will be perceived with a correct saturation, as indicated on the left-hand side of FIG. 5a. However, due to the difference of the colors perceived between transmission and reflection (FIG. 3), the observer will see an incorrect saturation if he/she views the same image in reflection. In the example illustrated by FIG. 5, the observer sees a higher saturation in the reflection view, as indicated in the right-hand side of FIG. 5a, in which the color patches 4a, b are shown with a higher density of hatch lines and dots.

A complementary situation is found when the image is printed with the reflection color profile, illustrated in FIG. 5b. Now, the observer will see a correct saturation in the reflection view (right-hand side of FIG. 5b), but an incorrect saturation in the transmission view (left-hand side of FIG. 5b). In the present example, the saturation is then too low, as illustrated by a lower density of the hatch lines and points in the left-hand side color patches of FIG. 5b.

By contrast, referring now to FIG. 5c, if the image is printed with a combined transmission-reflection color profile, which represents a color-reproduction compromise, neither in the transmission view nor in the reflection view is the color saturation absolutely correct. Rather, one has to imagine the correct saturation as lying between the transmission-view and reflection-view saturations. As a consequence of this color-reproduction compromise, the color distances between the transmission-view saturation and the correct saturation, and the reflection-view saturation and the correct saturation, are smaller than the distances between the correct saturation and the incorrect saturation in FIGS. 5a and 5b. In the present example, the transmission-view saturation is a little bit lower than the correct saturation, and the reflection-view saturation is a little bit higher (this is indicated in FIG. 5c by densities of hatch lines and dots which, though they differ from the correct-saturation densities, are closer to the correct-saturation density than the incorrect saturations of FIGS. 5a and 5b). Although the absolute saturation difference between the transmission and reflection views is the same in all the FIGS. 5a-5c, the small deviations in FIG. 5c from the correct saturation are hardly noticed. This is due to the fact that the observer does normally compare the colors perceived in the transmission and reflection views, but will rather notice when the colors in an image deviate too much from the correct saturation, as in FIGS. 5a and 5b in the transmission view and the reflection view, respectively. Therefore, with the color-reproduction compromise, a good color reproduction is achieved in both the transmission and the reflection views.

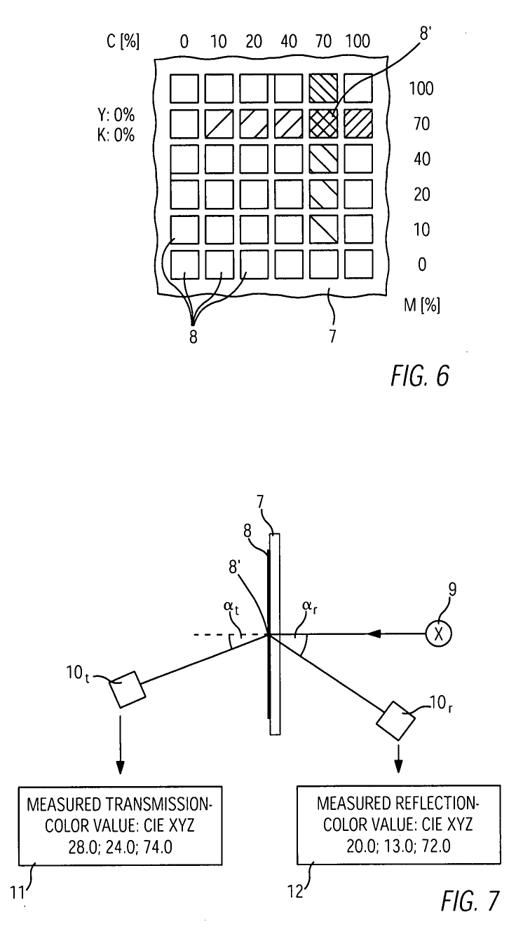

FIG. 6: Profiling Target:

To produce a combined transmission-reflection color target of the kind described above, first a profiling target is printed on a transparency with the printing device for which the color profile is destined. FIG. 6 illustrates an exemplary profiling target 7; only a section of a complete target is shown. The profiling target 7 is a transparency with a matrix-like arrangement of different color patches 8 with 0%, 10%, 20%, 40%, 70% and 100% of each ink (C, M, Y and K) in all possible combinations printed on it. In the exemplary section of FIG. 6, the thirty-six combinations of 0%, 10%, 20%, 40%, 70%, 100% C and M for 0% Y and 0% K are shown (the different colors are only illustrated for the matrix's 70% line and the 70% rows with different cross hatches). A profiling target may have additional color patches, for example ramps of each ink using finer increments. A frequently used profiling target is the IT8.7/3 which is, for example, shown in Fraser, page 105.

An embodiment of the process of making a combined transmission-reflection device color profile is explained below in an exemplary manner by singling out one of the color patches, the 70% C-70% M-0% Y-0% K color patch, which is denoted by 8′ in FIG. 6. Of course, many (or all) of the color patches 8 are actually used to make the color profile.

FIG. 7: Transmission and Reflection Measurements of Colors Produced by the Profiling Target:

The profiling target's colors, as seen by a standard observer, are then measured in a measurement process illustrated in FIG. 7. The profiling target 7 is illuminated by a light source 9, for example a Standard Illuminant D50 or D65, which simulates the daylight. The profiling target's print side (on which the color patches 8 are printed) is turned away from the light source 9, and the target's backside faces the light source 9, so that the color measurements are performed with an orientation consistent with the orientation in which the printed transparencies are later to be adhered to windows, as shown in FIG. 4. The colors perceived by a standard observer in transmission and in reflection are measured by color measurement devices 10ₜ and 10ᵣ, respectively. The measurement devices 10ₜ and 10ᵣ are, for example, spectrophotometers with spectral sensitivities according to the CIE standard observer; consequently, they provide, for each color patch, three numbers; this triple represents the CIE XYZ color values perceived by the standard observer in transmission and reflection, respectively. The optical detectors 10ₜ and 10ᵣ have an optical system with an aperture, the aperture angle of which is sufficiently small to ensure that only one of the color patches 8 is seen at a time. The measurement of the different color patches 8 may be made by subsequently directing the optical sensors 10ₜ,10ᵣ to the respective color patch 8. Of course, the transmission and reflection measurements may also be made by only using one and the same optical measurement device 10 for both the transmission and reflection measurements. The angles between the illuminating light ray and the transmitted and reflected light rays going to the optical detectors 10ₜ and 10ᵣ are denoted by αₜ and αᵣ in FIG. 7. They are chosen in a way to correspond to the average angle in which observers typically view transparency adhered to windows. For example, αᵣ may be chosen at 45°, whereas αₜ may be smaller, e.g. 15°.

The exemplary color patch 8′ of the profiling target (FIG. 6) produced by 70% C, 70% M, 0% Y, 0% K is perceived as “blue”. For example, the transmission-measurement device 10ₜ, when measuring the exemplary color patch 8′, may output a measured transmission-color value 11 of: X: 28.0; Y: 24.0; Z: 74.0. For the reflection observer, the color may appear with a higher color saturation, when the transparency's backside is viewed in reflection, as explained in FIG. 3. For example, the reflection-measurement device 10ᵣ, when viewing the exemplary color patch 8′, may output a measured reflection-color value 12 of: X: 20.0; Y: 13.0; Z: 72.0. The XYZ values are specified here in an eight-bit number space ranging from zero to 255 (zero being zero density, and 255 the maximum density). The position after the decimal point is only indicated for the purpose of illustration; in an eight-bit implementation the measured values may be rounded to integers, and the decimal point and the position after it may be omitted.

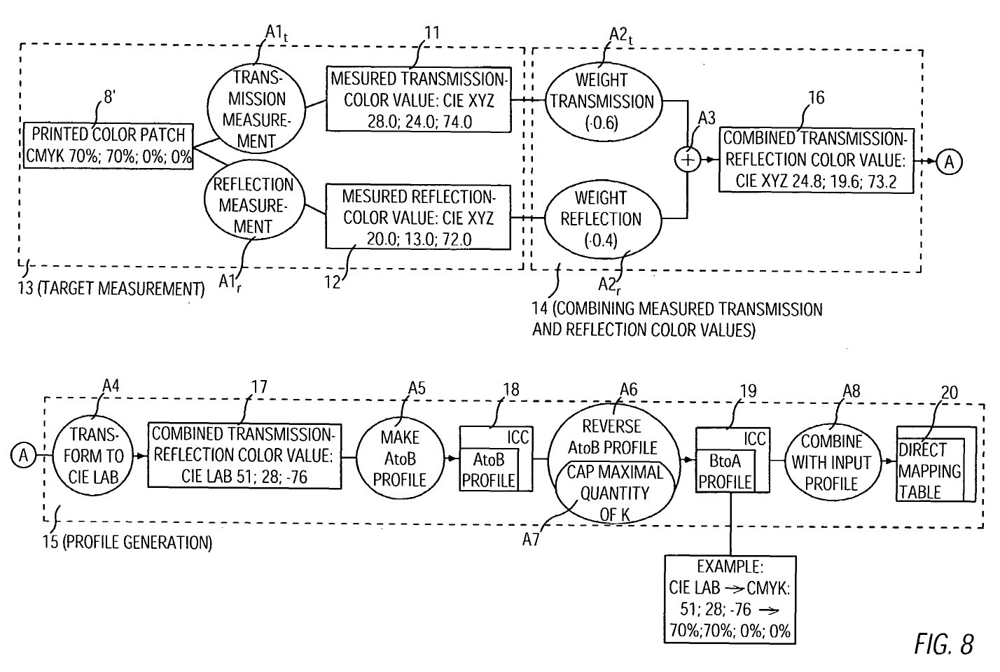

FIG. 8: Generation of Combined Transmission-Reflection Device Color Profiles:

A workflow for making combined transmission-reflection device color profiles is illustrated in FIG. 8. Activities are illustrated by circular boxes, and products of activities by rectangular boxes.

A first part 13 of the workflow pertains to the target color measurements already explained above, the second part 14 to combining the measured transmission and reflection color values and the third part 15 to profile generation.

In the first part 13, the colors of the printed color patches are measured in transmission, A1ₜ, and reflection A1ᵣ. As a result, the measured transmission color values 11 and reflection color values 12 are obtained, as already explained in FIG. 7.

The second part 14 of the workflow for combining the measured transmission and reflection color values, may either be made for each pair of measured color values, immediately following the measurement, or by first measuring the color-values pair of all the target's color patches, and only then combining them pairwise. The measured transmission and reflection color values are linearly combined, i.e. added with certain weightings. In order not to change the average luminance of the pair of color values of a color patch measured, the weights are normalized, i.e. their sum is one. In the example shown in FIG. 8, the measured transmission color values get a weight of 60%, and the measured reflection color values a weight of 40%. Consequently, the transmission-color value 11 of the exemplary color patch 8′ is multiplied by 0.6, and the reflection-color value 12 of the same color patch 8′ is multiplied by 0.4, at A2ₜ and A2ᵣ. The resulting numbers are then summed at A3. The combined transmission-reflection color value is denoted by 16. For the exemplary color patch 8′, the combined value 16 is: X: 24.8; Y: 19.6; Z: 73.2. These XYZ numbers represent a “blue” between the more saturated blue of the color patch 8′ perceived in reflection and the less saturated blue perceived in transmission.

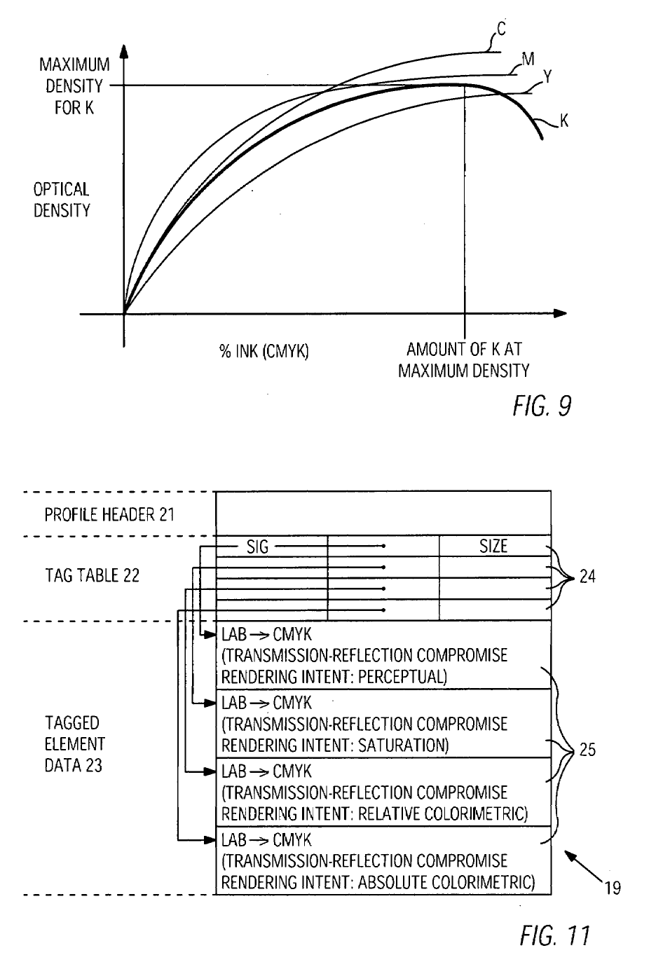

In the third part 15 of the workflow, the combined transmission-reflection color values 16 of many, or all, of the color patches 8 are processed into a BtoA profile, which maps colors expressed in a standard-observer based color space to the printing device's CMYK values, or to profile in the form of a direct-mapping table which directly maps colors expressed in an input color space (such as sRGB) to CYMK values. First, at A4, the combined transmission-reflection color values 16 are transformed from the linear, but perceptually non-uniform CIE XYZ color space to the non-linear, but perceptually uniform CIE LAB color space. The resulting combined CIE LAB color values are denoted by 17. For the combined color value originating from the exemplary color patch 8′ the resulting CIE LAB value is: 51; 28; −76 (using the D50 Standard Illuminant). In a 3×8 bit representation, the numbers for “L” may range from 0 to 255, and the numbers for “A” and “B” may range from −128 to +127. At A5, an AtoB profile is made using the combined transmission-reflection color values 17 as an input. As a result, an AtoB profile 18 is obtained, for example, according to the ICC standard (or ICM) for color profiles. Such a profile maps CMYK values of the particular printer used to print the target 7 to standard-user-defined colors, expressed in the CIE LAB color space. At A6, the AtoB profile is reversed. As a result, a BtoA profile 19 is obtained, for example in the ICC or ICM format. It is a lookup table mapping standard-user defined colors, expressed in the CIE LAB color space to CMYK values of the printing device used to print the target 7, which indicate the amounts of CMYK colorants to be used. In the process of making the BtoA profile 19, the maximum quantity of the amount of black ink used is limited to a “critical density” explained below in connection with FIG. 9; e.g. all K values above the critical density are set to the critical density. This activity of capping of the maximum amount of K is denoted by A7 in FIG. 8. Optionally, at A8, the BtoA profile 19 is combined with an input profile which, for example, maps color values expressed in an input color space, e.g. sRGB, to the device-independent color space, here CIE LAB. Combining the BtoA profile 19 with such an input profile results in a device color profile in the form of a direct-mapping table 20 which directly maps colors expressed in the input color space (e.g. sRGB) to CMYK values of the present printing device.

In order to illustrate the BtoA profile 19, the mapping of an exemplary CIE LAB value is also shown in FIG. 8: the CIE LAB value 51; 28; −76 is mapped to CMYK 70%; 70%; 0%; 0%. This exemplary mapping incorporates a color-reproduction compromise between mappings that would be used if true-color reproductions were used for transmission or reflection. For example, if a BtoA profile optimized for transmission were used (by using only the measured transmission-color values 11 in the workflow of FIG. 8), the exemplary color CIE LAB 21; 28; −76 would be printed with about CMYK 80%; 80%; 0%; 0%, which would result in a more saturated blue than the blue obtained with the color-reproduction compromise CMYK 70%; 70%, 0%; 0%. Analogously, if a BtoA profile optimized for reflection values were used (by using only the measured reflection-color values 12 in the workflow of FIG. 8), the exemplary color CIE LAB 51; 28; −76 would be printed with about CMYK 63%; 63%; 0%; 0%, which would result in a less saturated blue than the blue printed with the color-reproduction compromise. Thus, the color printed with the color-compromise BtoA profile 19 or the profile 20 is not perceived as a true color, neither in transmission nor reflection, but it appears very close to the true color in both transmission and reflection.

FIG. 9: Limiting the Amount of Black Ink Used:

FIG. 9 is a graph illustrating the optical density achieved as a function of the percentage of ink applied, separately for the four inks CMYK. For the “colored” inks, CMY, although the slope of the density curve decreases with an increasing amount of ink, i.e. the density is saturated, the slope does not become negative. However, for some inks, black shows a different behavior: the optical density of K increases with an increasing amount of black ink, as for the colored inks CMY. The optical density for black then shows a maximum density, and for still higher amounts of black ink, the optical density starts to decrease, i.e. its slope becomes negative, as shown in FIG. 9. The maximum density is also called “critical density”, and the amount of K at the maximum density is also called the “critical amount of K”.

As already mentioned above, the observation that, for some inks, the density curve of black has a critical density and a negative slope beyond the critical density, may be due to the fact that, at very high concentrations of liquid black ink, the black pigment starts to crystallize, which has the effect of reducing the optical density.

To avoid such a reduction in optical density, when the AtoB profile 19 is made at A6 (FIG. 8), the amount of black ink is capped at the critical density, e.g. by replacing numbers which represent an amount of K beyond the critical density by the amount of K at the critical density in the BtoA profile 19 produced.

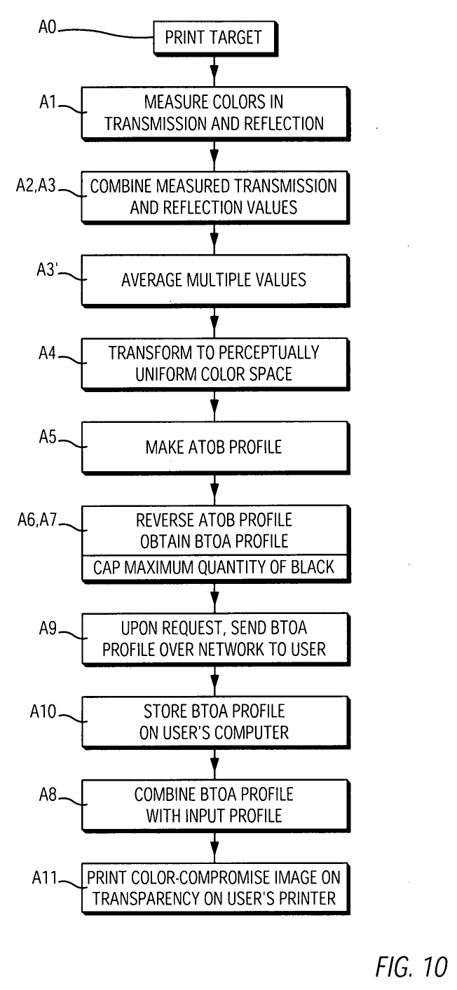

FIG. 10: High-Level Flow Diagram:

FIG. 10 is a high-level flow diagram including the workflow of FIG. 8, and, furthermore, the activities of transmitting and storing the generated device color profile and printing an image on a transparency using it.

At A0, the profiling target is printed. Of course, A0 may be omitted if a suitable printed target is already available. At A1, the colors are measured in transmission and reflection (FIGS. 7 and 8). At A2, A3 the pairs of measured transmission and reflection values belonging to a color patch are combined (FIG. 8). As already mentioned, in some cases it may be advantageous to measure each of the target's color patches not only once in transmission and reflection, but to make many such measurements, for example using different targets, different illumination conditions (e.g. for different light sources or various illumination angles) and/or different measurement conditions (e.g. various measurement angles αₜ, αᵣ (FIG. 7)). Accordingly, at A3′, the combined color values of such multiple measurements of one color patch are averaged; in other embodiments with multiple measurements, the measured transmission values of a color patch are first averaged to an average transmission value, and the measured reflection values of a color patch are first averaged to an average reflection value, and the pairs of averaged transmission values and of averaged reflection values are only then combined to an averaged combined value.

At A4, the averaged combined transmission-reflection values are transformed to a perceptually-uniform color space, such as the CIE LAB space (FIG. 8). At A5, an AtoB profile is generated and, at A6, the AtoB profile is reversed to obtain the BtoA profile (FIG. 8). As a part of the activity to reverse the AtoB profile, the maximum quantity of black is capped at A7, as explained in connection with FIGS. 8 and 9.

The activities which follow pertain mainly to the transmission and use of the device color profile thus obtained. In some of the cases, the BtoA profile, or a profile in the form of a direct-mapping table derived from it, incorporating the transmission-reflection reproduction compromise, will be commercialized as a part of a computer's operating system or a printer driver already pre-installed on the computer or printer, or on a computer-readable medium with or without the computer or printer. In other cases, the BtoA profile or the direct-mapping profile will be sent, upon request, to a user over a network, for example the Internet, at A9. The BtoA profile, or the direct-mapping profile, may be downloaded itself, or along with other device color profiles or combined with a printer driver or an operating system. At A10, the BtoA profile or the direct-mapping table is stored on the user's computer. If a direct-mapping profile has not yet been generated at an earlier stage, the BtoA profile may now be combined with an input color profile, to form the direct-mapping table 20 (FIG. 8), at A8.

Finally, at All, the user prints an image on a transparency by means of the user's printer, using the BtoA profile 19, or the direct-mapping table 20, which incorporates the transmission-reflection color reproduction compromise. Consequently, the color image printed, although being no true-color print, appears very close to the true color in both transmission and reflection.

FIG. 11: Device Color Profile:

FIG. 11 illustrates the device color profile 19 in more detail. In the example shown, all elements of the profile 19 are contained in a single file according to the ICC.1:2001/12 file format for color profiles. The profile has a profile header 21, a tag table 22 and tagged element data 23. The profile header 21 contains different header data, such as profile size, profile version number, date and time of profile creation, primary-platform signature, profile ID, etc. The tag table 22 contains tags 24 (i.e. references) to the element data 23. Each tag contains a tag signature, a reference to the data element tagged by the tag and, since the element data may be of various sizes, a number indicating the size of the tagged element data. The element data 23 are, for example, four different BtoA lookup tables 25, one for each of the standardized rendering intents. All the tables 25 incorporate the transmission-reflection color reproduction compromise, as explained above.

FIG. 12: Program Structure of a Computer Including Device Color Profiles:

FIG. 12 is a high-level diagram of a computer's program structure 33. The program structure 33 is subdivided into an operating system (OS) layer 26 and an application layer 27. The OS layer 26, for example, may include the Macintosh® or Windows® operating system 28. The computer itself is a commercially available multi-purpose computer, e.g. arranged to work with the Macintosh® or Windows® operating system. The OS layer 26 also includes input/output modules, such as an input handler 29 and a printer driver 30. The input handler 29 may, for example, be connected to a device for producing digital input images, e.g. a digital camera 31, a scanner, etc. It may likewise be a network interface which may, inter alia, receive input images over a network. The printer driver 30 is connected to a printing device 32, e.g. an ink-jet printer. The printing device 32 is, i.a., suitable to print color images on transparencies 2.

The operating system 28 includes a part 34 which provides color management services (e.g. services in the framework of the ColorSync® or ICM® technologies), basically the service of transforming color values from one color representation into another. Of course, those transforms which are defined by color-compromise profiles are not the usual transforms of a color from one representation into another, but rather they include a “modification” of the color in the sense of the transmission-reflection color-reproduction compromise described above. To this end, the color-management services part 34 is arranged to access device color profiles, which are, for example, files in the ICC or ICM format stored in the computer's memory. At least one of these profiles, is a profile incorporating a transmission-reflection reproduction compromise, e.g. the BtoA profile 19 and/or the profile in the form of a direct mapping table 20 (FIGS. 8 and 11).

User applications, such as the color-management application 35, are processed in the application layer 27. The color-management application 35 may be an application for explicit color management, such as Adobe® Photoshop®, including a color management machine (CMM) 36.

Both applications, such as the color-management application 35, and device drivers, such as the printer driver 30, can make use of the color management services 34 provided by the operating system 28. For example, if an image represented in the color-management application's intermediate color space (e.g. CIE LAB, Adobe®RGB, sRGB, etc.) is to be transformed into a CMYK representation incorporating the described transmission-reflection color reproduction compromise, the color management application 35 passes the original image data to the color management services 34, together with a request to transform them, and the color management services 34 perform the requested transformation by using the profile 19 or 20 and return the image data transformed to CMYK, which incorporates the reproduction compromise, to the color-management application 35. The image may then be printed by the printing device 32 via the printer driver 30. In other cases in which no application for explicit color management is used, the printer driver 30 may receive image data with colors represented in an input or intermediate color space, such as RGB specific for the digital camera 31, sRGB for images received via the Internet, Adobe RGB, CIE LAB etc. In those cases, the printer driver 30 passes these data to the color management services 34, together with a transformation request, whereupon the color management services 34 transform them into a CMYK representation including the reproduction compromise, by using the profile 19 or 20, and return the transformed CMYK representation incorporating the reproduction compromise to the printer driver 30. The printer driver 30 outputs the CMYK data to the printing device 32 to cause it to print a color-compromise image on a transparency 2.

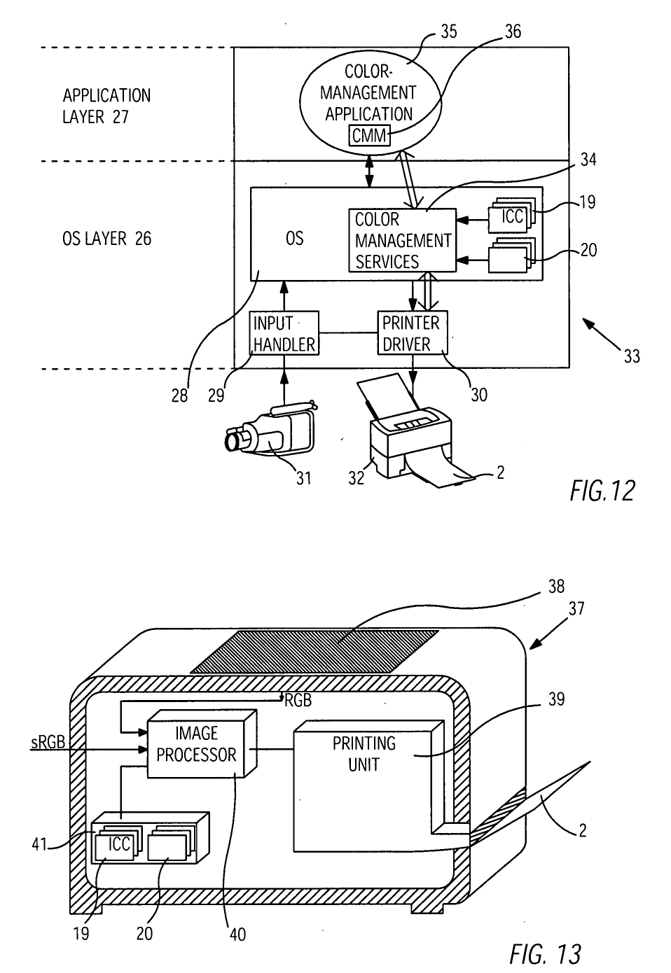

FIG. 13: Printing Device

FIG. 13 illustrates a printing device 37, here a copier including a scanner 38 and a printing unit 39 (e.g. an ink-jet printing unit). The scanner 38 is arranged to generate a digital-color representation of scanned images; the colors are expressed in a scanner-dependent representation, denoted by “RGB” in FIG. 13. An image processor 40 is arranged to receive the image data from the scanner 38 or, alternatively, other input data, for example in a device-independent color representation, such as sRGB (if only such external input images are to be printed, the scanner 38 may also be omitted). The image processor 40 may access a memory 41 which, i.a., stores device color profiles 19 and/or 20 incorporating a transmission-reflection color reproduction compromise, as described above. The image processor 40 is arranged to transform an input image into a CMYK color compromise image. The printing unit 39 is arranged to print this image on a transparency 2.

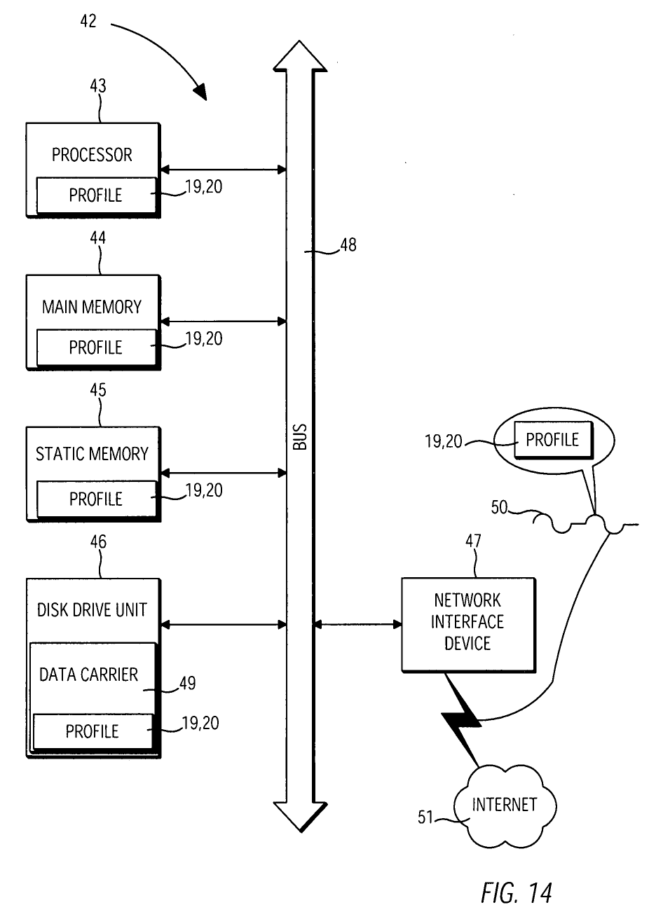

FIG. 14: High-Level Architecture Diagram of a Computer with Device Color Profiles:

FIG. 14 is a high-level architecture diagram of a computer system 42, hosting the program structure 33 (FIG. 12), with device color profile stored on it, or transmitted to it via a network, e.g. the Internet 51, in the form of a propagated signal transmitted over the network. The computer system 42 includes a processor 43 and memory, such as a main memory 44, a static memory 45 and/or a disk drive unit 46, as well as a network interface device 47, which communicate with each other via a bus 48. One or more profiles 19, 20 incorporating the transmission-reflection color reproduction compromise, as described above, may be stored in or on a machine-readable medium, e.g. the processor 43, the main memory 44 and/or the static memory 45. A machine-readable medium on which the profile 19, 20 is stored may also be a data carrier 49 (e.g. a non-removable magnetic hard disk or an optical or magnetic removable disk) which is part of the disk drive unit 46. The profile 19, 20 may further be transmitted or received as a propagated signal 50 via the Internet 51 through the network interface device 57.

Thus, a general purpose of the disclosed embodiments is to provide methods and products which enable color images to be printed on transparencies with a good color reproduction when viewed both in transmission and reflection.

All publications and existing systems and methods mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method of generating a device color profile for printing, with a printing device, on a translucent or transparent media, comprising:
printing a profiling target on the media;
measuring color values produced by the profiling target, when illuminated in transmission and when illuminated in reflection, in a device-independent color space;
combining the transmission and reflection color values into combined transmission-reflection color values and creating a combined transmission-reflection profile mapping color values from a device-dependent color space to the device-independent color space;
reversing the combined transmission-reflection profile, thereby obtaining a device color profile which maps color values from a device-independent color space to the device-dependent color space in a manner which represents a color-reproduction compromise between transmission and reflection.

2. The method of claim 1, wherein the color values measured represent a standard observer's tristimulus response to the profiling target.

3. The method of claim 1, wherein the device-independent color space in which the measured colors are represented is a perceptually non-uniform color space.

4. The method of claim 3, wherein the color values measured are CIE XYZ color values.

5. The method of claim 3, wherein the transmission and reflection color values are combined in the perceptually non-uniform color-space representation.

6. The method of claim 1, wherein the transmission and reflection color values to be combined are represented in the CIE XYZ color space or the CIE LAB color space.

7. The method of claim 1, wherein the combined transmission-reflection color values are linear combinations of the transmission and reflection color values.

8. The method of claim 1, wherein the transmission and reflection color values are combined with proportions X% transmission and 100%−X% reflection, wherein X lies in a range from 30 to 70.

9. The method of claim 1, wherein, in combining the transmission and reflection color values, the proportion of the transmission color values is larger than the proportion of the reflection color values.

10. The method of claim 1, wherein the combined transmission-reflection values, or the combined transmission-reflection profile, are first transformed into a perceptually uniform color-space representation, before the reversal to obtain the device color profile is made.

11. The method of claim 1, wherein the combined transmission-reflection profile to be reversed is represented in the CIE LAB color space.

12. The method of claim 1, wherein the device-dependent color space is a CMY or CMYK color space.

13. The method of claim 1, wherein the combined transmission-reflection profile and the device color profile are lookup-table-based.

14. The method of claim 1, wherein the device color profile has an ICC profile format.

15. The method of claim 1, further including:
connecting the device color profile, which is a destination profile, with a source profiles which maps input-color values from an input-color space to the device-independent color space, to form a table mapping input-color values to device-dependent color values in a manner which represents a color-reproduction compromise between transmission and reflection.

16-24. (canceled)

25. The method of claim 1, wherein more than one set of transmission and reflection color measurements is performed, either using the same profiling target or different profiling targets, and the results of the different sets of measurements are averaged, either before or after combining the transmission and reflection color values.

26. The method of claim 1, wherein, in the measurement, the media is illuminated and is orientated such that the media's side on which the profiling target is printed is the side which is not facing the light source.

27. The method of claim 1, wherein the printing device uses black ink, and a relationship between optical-density and the amount of black ink applied has a maximum at a critical value, wherein the maximum amount of black ink applied to the transparent media is limited to a value below the critical value.

28. A printing device arranged to print on a translucent or transparent media,
said printing device being equipped with a device color profile, or a table, which comprises a mapping of color values from a device-independent color space, or an input-color space, to a printing-device-dependent color space in a manner which represents a color-reproduction compromise for the media when observed in transmission and in reflection,
wherein said device color profile, or table, incorporates a combination of transmission and reflection color values.

29. A machine-readable medium with data stored on it,
said data comprising a device color profile which represents a mapping of color values from a device-independent color space to a device-dependent color space, for providing a printing device with information enabling it to translate input-color values expressed in the device-independent color space,
said device color profile, when stored in or accessed by the printing device or a computer arranged to control the printing device, enables the printing device to reproduce colors on a translucent or transparent media in a manner which represents a color-reproduction compromise for the media when observed in transmission and in reflection,
wherein said device color profile incorporates a combination of transmission and reflection color values.
